(19) United States
(12) Patent Application Publication
(10) Pub. No.: US 2013/0114268 A1
(43) Pub. Date: May 9, 2013

(54) Light Emitting Device

(71) Applicants: Daisuke Shigematsu, Osaka (JP); Kazuki Mashiro, Osaka (JP)

(72) Inventors: Daisuke Shigematsu, Osaka (JP); Kazuki Mashiro, Osaka (JP)

(21) Appl. No.: 13/727,797

(22) Filed: Dec. 27, 2012

Related U.S. Application Data
(63) Continuation of application No. PCT/JP2011/063830, filed on Jun. 16, 2011.

(30) Foreign Application Priority Data
Jun. 30, 2010 (JP) 2010-148427

(51) Int. Cl. F21V 13/04

(52) U.S. Cl. CPC F21V 13/04
USPC 362/308

(57) ABSTRACT

A light emitting device which is substantially free from misrecognition occurring due to external light and is less conspicuous. The light emitting device includes an inner lens subjected to a half mirror treatment and provided around a light emitting member. The inner lens is tubular, and has a half mirror formed on an outer peripheral surface thereof by metal coating. The inner lens surrounds the light emitting member, and its lower portion is retained by a case. An engagement cover is attached to an upper portion of the inner lens. Thus, the inner lens is fixed to the outer cover, and prevents external light from intruding into the inner lens.

### FIELD OF THE INVENTION

The present invention relates to a light emitting device.

### BACKGROUND OF THE INVENTION

A light emitting device, particularly a signaling lamp employing the light emitting device, includes one or more light sources (LEDs or the like) provided therein, and a reflection member for reflecting light emitted from the light sources. The light emitting device further includes a transparent globe covering the light sources and the reflection member, and a divergent lens provided on a surface of the globe for diverging light passing therethrough. The light sources may be adapted to emit a plurality of color light beams.

PTL1: JP-2000-353401A

With a signaling lamp of PTL1, however, external light incident on the transparent globe is liable to pass through the transparent globe to be further incident on the reflection member. Then, the incident light is reflected outside the globe. This may result in misrecognition such that, though the internal light sources actually emit no light, the light sources look lighting. A signaling lamp mounted on an intended equipment machine or the like is merely required to light or blink when it is necessary to provide information. When it is not necessary to provide information, the signaling lamp is desirably inconspicuous.

It is, therefore, an object of the present invention to provide a light emitting device which is substantially free from misrecognition occurring due to external light. It is another object of the present invention to provide a less conspicuous light emitting device.

### SUMMARY OF THE INVENTION

The present invention provides a light emitting device including a light source and an inner lens through which light emitted from the light source passes, wherein the inner lens is a half mirror. According to the present invention, the inside of the device including the light source is prevented from being seen through with the provision of the half mirror. The external light is reflected on a surface of the inner lens and, therefore, less liable to enter the inside. Even with provision of a reflection mirror inside the inner lens, therefore, reflection of the external light on the reflection mirror is eliminated, thereby reducing the possibility of misrecognition such that the light emitting device looks lighting in an unlighting state. The light source is provided inside the half mirror and, when it is not necessary to provide information, i.e., when the light emitting device is in the unlighting state, the inside of the light emitting device is not seen. Therefore, the light emitting device has a neat external appearance. Where the light emitting device is mounted on an equipment machine of a metallic design, the half mirror and the metallic design synergistically make the light emitting device less conspicuous in the unlighting state.

In the present invention, an outer cover for protecting the half mirror or ensuring the reliability of the light emitting device may be provided outside the inner lens. This prevents a damage to the surface of the inner lens, and improves the water resistance, the dust resistance or other resistance reliability of the light emitting device.

In the present invention, the half mirror may include a plurality of half mirrors having different optical properties. The reflectance, the transmittance, the color and other optical properties of the half mirror can be selected according to the optical properties of the accommodated light source. This makes it possible to indicate the presence of the light emitting device by a change in the optical properties of the half mirror, while making the light emitting device less conspicuous.

In the present invention, the half mirror may include a plurality of half mirrors having different colors. In this case, the color of the half mirror can be selected according to the color of the light emitted from the light source. This makes it possible to indicate the presence of the light emitting device by the color of the half mirror, while making the light emitting device less conspicuous.

In the present invention, the half mirror may be provided as a part of the inner lens. Where the light emitting device is of a wall-mounted type or is not required to provide signaling on the entire periphery thereof, a component unnecessary for the signaling may be provided as a separate member. Thus, the light emitting device can be provided at lower costs. Further, the effects described above can be provided.

In the present invention, the light source is mounted on a substrate which has a surface subjected to a light diffusion treatment. In this case, a diffusion material is provided for diffusing the light reflected inside the half mirror. Thus, both the light source disposed inside the inner lens and the substrate surface illuminate when the light emitting device is in a lighting state, so that the inside substrate is less visible through the inner lens. This makes the light emitting device less conspicuous, while permitting the light emitting device to properly function as the signaling lamp.

The half mirror may be partitioned into a plurality of portions by a nontransparent portion or a half mirror having a higher reflectance according to an accommodated light source position and a light emitting direction. This improves a contrast between the lighting state and a blinking state of the light source.

In the present invention, the inner lens may have a tubular shape to surround the light source. This facilitates the assembling of the light emitting device. Further, a space surrounded by the half mirror can be provided into which the external light is less liable to intrude. That is, the contrast between the lighting state and the unlighting state can be provided, thereby substantially preventing the lighting misrecognition which may otherwise occur due to the external light.

In the present invention, the light emitting device may include a case to which the inner lens is attached, and the case may retain a lower portion of the tubular inner lens in a self-standing state and have a lamp retaining portion which prevents the external light from intruding into the inner lens. This facilitates the assembling of the light emitting device. Further, the space surrounded by the half mirror can be provided into which the external light is less liable to intrude. That is, the contrast between the lighting state and the unlighting state can be provided, thereby substantially preventing the lighting misrecognition which may otherwise occur due to the external light.

In the present invention, the light emitting device may include an outer cover provided outside the inner lens, and an engagement cover attached to an upper portion of the inner lens, and the engagement cover may be configured to be resiliently engaged with an upper inner surface portion of the outer cover. This makes it possible to stably retain the inner lens in the outer cover, thereby stably providing a signaling function as the light emitting device, particularly as a signaling lamp. The engagement cover may be defined by an upper face of the outer cover.

In the present invention, the inner lens may be partly exposed outside the outer cover. This makes it easier to radiate the light of the light source outside. Where the outer cover has the same color as or a similar color to the inner lens, the sense of unity of the overall light emitting device can be increased. In addition, the sense of unity between the light emitting device and an equipment machine on which the light emitting device is mounted can be increased by matching the color of the outer cover to the exterior color of the equipment machine, making the light emitting device less conspicuous.

In the present invention, the inner lens and the outer cover may be unitarily provided. This permits the outer cover to double as the inner lens depending on a use environment, thereby providing the light emitting device at lower costs.

### BRIEF DESCRIPTION OF THE DRAWINGS

FIG. 1 is a front view of a light emitting device according to a first embodiment of the present invention.

FIG. 2 is an exploded perspective view of the light emitting device according to the first embodiment of the present invention as seen from an upper side.

FIG. 3 is an exploded perspective view of the light emitting device according to the first embodiment of the present invention as seen from a lower side.

FIG. 4 is a vertical sectional view of the light emitting device of FIG. 1 taken along a line S1-S1.

FIG. 5 is an exploded perspective view of a light emitting device according to a second embodiment of the present invention as seen from an upper side.

FIGS. 6A-6C show a front view (6A), a bottom view (6B) and a right side view (6C) illustrating a light emitting device according to a third embodiment of the present invention.

FIG. 7 is an exploded side view of the light emitting device according to the third embodiment of the present invention.

FIG. 8 is a front view of a light emitting device according to a fourth embodiment of the present invention.

### DETAILED DESCRIPTION OF THE INVENTION

Embodiments of the present invention will hereinafter be described in detail with reference to the attached drawings.

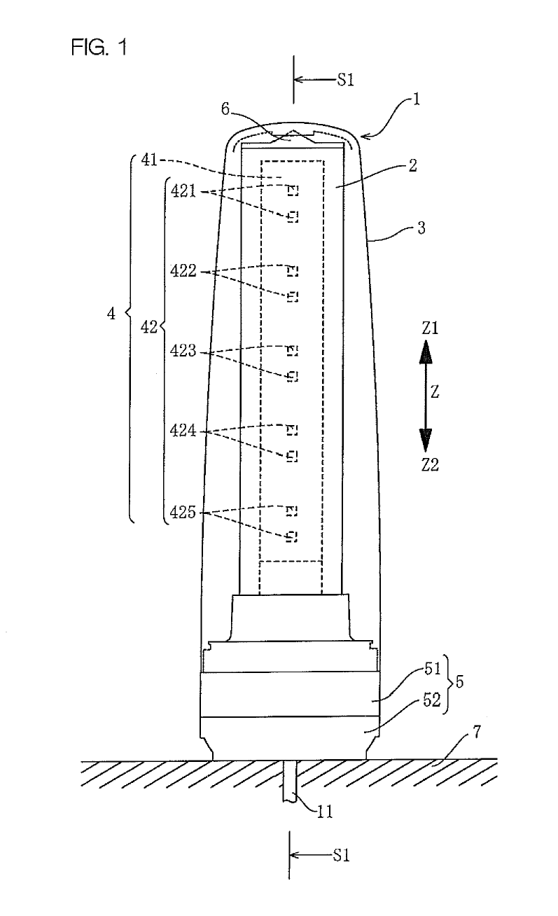

FIG. 1 is a front view of a light emitting device 1 according to a first embodiment of the present invention. Referring to FIG. 1, the light emitting device 1 has a column shape elongated in one direction. The light emitting device 1 is mounted on an upper surface of an object (e.g., an equipment machine 7) with its longitudinal axis aligned with a vertical direction Z (an upward direction and a downward direction indicated by arrows Z1 and Z2, respectively) to function as a signaling lamp.

The inventive light emitting device can be employed not only as the signaling device but also as an indicator such as a lighting device, a rotating warning lamp or a road sign. In this embodiment, the signaling lamp will be described according to the present invention by way of example.

The light emitting device 1 includes a case 5 for mounting the light emitting device 1 on the equipment machine 7, a light emitting member 4 supported by the case 5, an inner lens 2 provided around the light emitting member 4, an outer cover 3 surrounding the inner lens 2, an engagement cover 6 which engages an upper portion of the inner lens 2 with the outer cover 3, and a wiring cable 11 for receiving a signal and power supplied from the equipment machine 7. The light emitting device 1 may be mounted with its longitudinal axis extending in a direction other than the vertical direction. In the description of this embodiment, the longitudinal axis is aligned with the vertical direction Z.

The light emitting member 4 serving as the light source includes a plurality of LEDs 42 (LEDs 421, 422, 423, 424, 425) and a substrate 41 on which the LEDs 42 are mounted. The substrate 41 is disposed upright along the vertical direction Z. The LEDs 42 may be of a single color light emitting type or of a multiple color light emitting type. The LEDs 42 are controlled for lighting and blinking based on a programmed control signal or an external control signal by an independent control method, a group control method or the like. For example, a blinking control operation may be performed with the LEDs 421, 422 operated in synchronism and with the LEDs 423, 424, 425 operated in synchronism in a cycle different from that for the LEDs 421, 422. In this embodiment, a red LED 421, a yellow LED 422, a green LED 423, a blue LED 424 and a white LED 425 are disposed in this order from an upper side of the substrate 41 of the light emitting device 1. In the description of this embodiment, the light emitting member 4 includes the plurality of LEDs mounted on the upright substrate 41, but the light emitting member 4 may include a reflection member in addition to the LEDs for reflecting light emitted from the LEDs. Light sources other than the LEDs may be employed for he light emitting member 4.

The case 5 includes a lower case 52 for mounting the light emitting device 1 on the equipment machine 7, and an upper case 51 attached to an upper portion of the lower case 52. The lower case 52 has a bottom through which the wiring cable 11 can be passed. The light emitting member 4, the inner lens 2 and the outer cover 3 are supported on an upper portion of the upper case 51. Although the outer cover 3 is mounted on the case 5 in this embodiment, the case 5 may be accommodated in the outer cover 3. In this case, a mounting method for mounting the light emitting device 1 on the equipment machine 7 is changed so that the light emitting device 1 except for the outer cover 3 is first mounted on the equipment machine 7 and then the outer cover 3 is mounted.

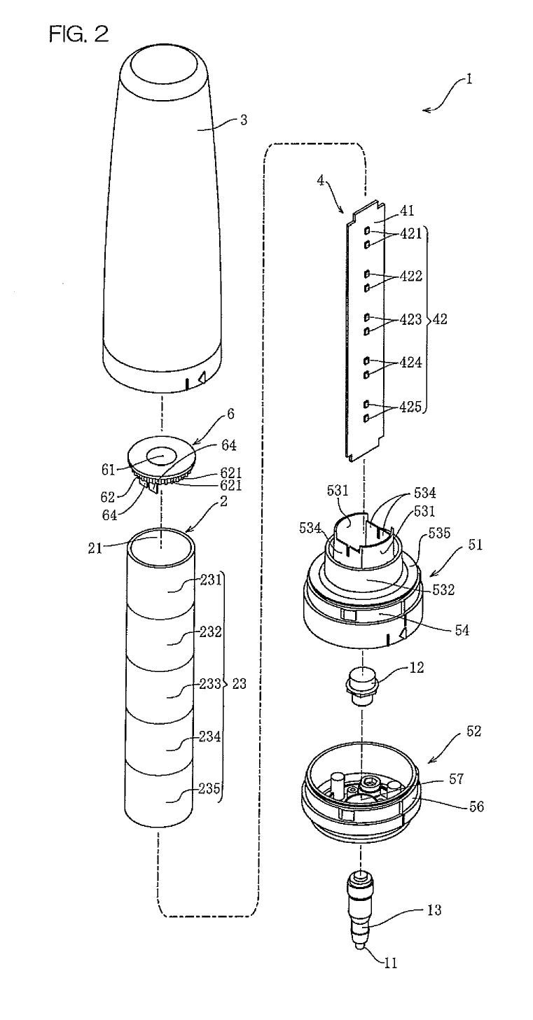

The inner lens 2 includes a light-transmissive tubular base made of a light diffusion material capable of diffusing the light emitted from the light emitting member 4, and half mirrors 23 (half mirrors 231, 232, 233, 234, 235) formed on an outer peripheral surface of the base by metal coating (see FIG. 2). Although the base is the light-transmissive tubular base of the light diffusion material in this embodiment, the base may be simply made of a transparent material and the half mirrors 23 may be formed on an outer peripheral surface of the transparent base by metal coating. In this embodiment, the inner lens 2 is formed as having a half mirror function by forming an aluminum metal coating on a base of a polycarbonate resin, an acrylic resin or glass.

The engagement cover 6 is made of an elastic material such as a silicon rubber or an elastomer, and is attached to an upper inner surface portion of the inner lens 2. The engagement cover 6 prevents unwanted light from intruding into the inner lens 2 from an upper side to improve the half mirror effect of the inner lens 2. The engagement cover 6 is pressed by the outer cover 3 for engagement with the outer cover 3.

The outer cover 3 is made of a transparent polycarbonate, a transparent acrylic resin or the like to define an external appearance of the light emitting device 1. The outer cover 3 is engaged with the upper case 51 with its lower end inner surface fitted around the upper case 51. At this time, the outer cover 3 is engaged with the inner lens 2 via the engagement cover 6 so as to suppress the movement of the inner lens 2. The outer cover 3 is used for the purpose of ensuring the reliability of the light emitting device 1 for water resistance, dust resistance and oil resistance. Without the need for consideration of this use purpose, the outer cover 3 may be obviated. In this case, the inner lens 2 may double as the outer cover 3. Further, an upper face portion of the outer cover 3 may be provided as a separate component, which is used instead of the engagement cover 6 to be engaged with the inner lens 2.

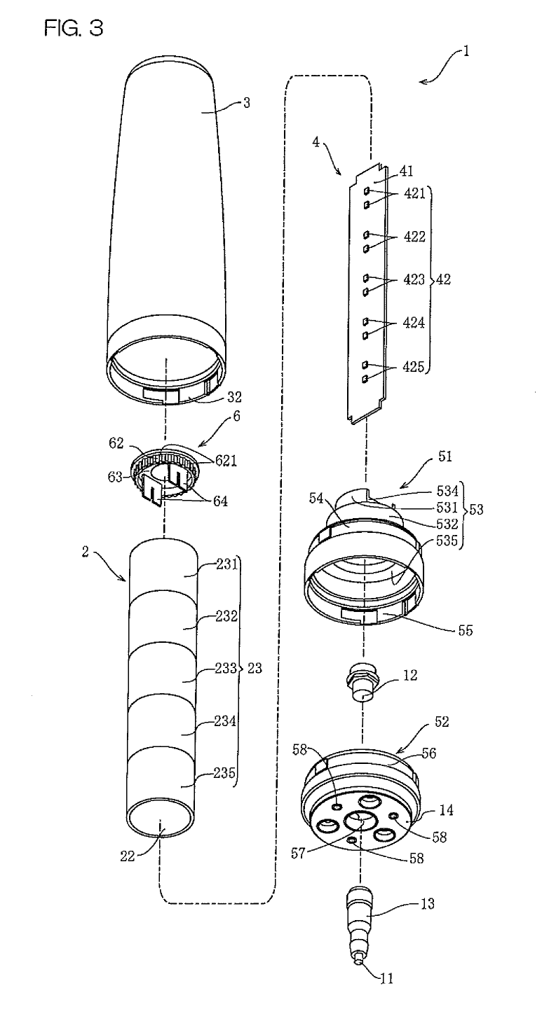

FIG. 2 is an exploded perspective view of the light emitting device according to the first embodiment of the present invention as seen from an upper side. FIG. 3 is an exploded perspective view of the light emitting device according to the first embodiment of the present invention as seen from a lower side.

Referring to FIGS. 2 and 3, the lower case 52 includes a bottom 14 having a wiring insertion hole 57 through which the wiring cable 11 extending from the equipment machine 7 is inserted and through-holes 58 for fixing the light emitting device 1 to the equipment machine 7 by screws, and an upper case attachment portion 56 provided on an upper outer peripheral surface portion thereof to be connected to the upper case 51 by a bayonet system. The wiring cable 11 and an external connector 13 provided at a distal end of the wiring cable 11 can be inserted through the wiring insertion hole 57. The distal end of the wiring cable 11 may be first passed through the wiring insertion hole 57 from the lower side to the upper side, and then the external connector 13 may be attached to the distal end of the wiring cable 11 from the upper side. After the external connector 13 is inserted through the wiring insertion hole 57 provided in a generally center portion of the bottom of the lower case 52, the external connector 13 is electrically and mechanically connected to an internal connector 12 in a waterproof state. In the description of this embodiment, the operation signal and the power are supplied via the wiring cable 11, but the operation signal may be supplied wirelessly. Further, the power may be supplied by a battery system.

The upper case 51 includes a lower case attachment portion 55 provided on a lower inner peripheral surface portion thereof to be connected to the lower case 52 by a bayonet system, and an outer cover attachment portion 54 provided on a vertically middle portion of an outer peripheral surface thereof to be connected to the outer cover 3 by a bayonet system. The lower case attachment portion 55 has an engagement projection provided on an inner peripheral surface thereof, and the outer cover attachment portion 54 has an engagement projection provided on an outer peripheral surface thereof, so that the lower case attachment portion 55 and the outer cover attachment portion 54 can be rotatively engaged with the lower case 52 and the outer cover 3, respectively, by the bayonet systems. The bottom 14 serves as the bottom of the lower case 52 and as the bottom of the light emitting device 1.

The upper case 51 has a lamp retaining portion 53 for retaining the inner lens 2 and the light emitting member 4. The lamp retaining portion 53 includes a pair of substrate retaining pieces 534, inner retention walls 531 and an outer retention wall 532 for retaining the inner lens 2, a peripheral edge portion 535 extending inward from an upper edge of the outer cover attachment portion 54, and an inner lens support base 533 to be described later.

The pair of substrate retaining pieces 534 are each formed in a plate shape, and each have a slit in which a lower end portion of the substrate 41 is inserted to be supported. The inner retention walls 531 are curved plates each having a partial cylindrical peripheral surface to be brought into contact with a lower inner peripheral surface portion of the generally cylindrical inner lens 2, and restrict the movement of the inner lens 2 when the inner lens 2 is attached. The inner retention walls 531 are connected to the substrate retaining pieces 534 to provide a sufficient mechanical strength when retaining the inner lens 2 and the substrate 41. However, the inner retention walls 531 may be obviated if the substrate retaining pieces 534 can be imparted with sufficient mechanical strength by other method. Although the substrate retaining pieces 534 retain the lower end portion of the substrate 41, other substrate retaining means may be used for retaining the substrate.

Similarly to the inner retention walls 531, the outer retention wall 532 functions to restrict the movement of the inner lens 2 during the mounting of the inner lens 2 and to prevent external light from intruding into the inner lens 2 from a lower portion of the inner lens 2. Further, the external retention wall 532 has a smaller height to increase the light radiation area of light emitted from the light emitting member 4 while preventing the intrusion of the external light. The inner retention walls 531 are the curved plates each having a partial cylindrical peripheral surface as described above, but the shapes of the inner retention walls 531 are not limited to the plate shape. The inner retention walls 531 may be each configured to include a plurality of rods. Where the light emitting device is used in a site less susceptible to vibrations and other influences, the inner lens 2 may be retained only by the outer retention wall 532 without the provision of the inner retention walls 531. Thus, the inner retention walls 531 may be obviated. Where the inner lens 2 can be supported only by the inner retention walls 531, for example, with a seal member provided on the bottom of the inner lens 2 for prevention of the intrusion of the external light into the inner lens 2, on the other hand, the outer retention wall 532 may be obviated. The peripheral edge portion 535 is provided integrally with the outer cover attachment portion 54, the outer retention wall 532 and the inner lens support base 533 to be connected to the outer cover attachment portion 54, the outer retention wall 532 and the inner lens support base 533.

A notched lower end portion of the substrate 41 of the light emitting member 4 is inserted in the substrate retaining pieces 534 to be retained by the substrate retaining pieces 534, and the lighting operation and the blinking operation of the mounted LEDs 42 are performed based on the signal and the power supplied via the internal connector 12. A portion of the substrate 41 except for a mounting surface is colored white for easier reflection of light or coated with a light diffusion material for a light diffusion treatment. This treatment is performed because the half mirrors 23 of the inner lens 2 reflect parts of the light emitted from the LEDs 42 toward the substrate 41. Therefore, the light reflected on the half mirrors 23 is easily reflected again toward the inner lens 2 for improvement of the performance of the light emitting device 1.

In this embodiment, the light emitting member 4 is configured so that the plurality of LEDs 42 are mounted on opposite surfaces of the elongated substrate with their optical axes extending horizontally not by way of limitation. Alternatively, the light emitting member 4 may be configured, for example, so that an LED is provided in a space surrounded by the inner retention walls 531 and the substrate retaining pieces 534 with its optical axis extending vertically and light emitted from the LED is reflected outward on a lens component or a reflection member formed by aluminum vapor deposition.

The outer peripheral surface of the inner lens 2 is treated for the half mirrors 23. More specifically, the half mirrors 23 include a red half mirror 231, a yellow half mirror 232, a green half mirror 233, a blue half mirror 234 and a white (silver) half mirror 235 which respectively match the colors of the light emitted from the LED 421, the LED 422, the LED 423, the LED 424 and the LED 425 provided inside the inner lens 2 and are disposed at positions corresponding to the LEDs 421, 422, 423, 424, 425. In this embodiment, the half mirrors 231, 232, 233, 234, 235 have substantially the same area, but may have different area ratios according to the use purpose. Only white (silver) half mirrors may be used as the half mirrors 23. Further, half mirrors having the same color but different light transmittances and different light reflectances may be used in combination.

The inner lens 2 has an upper case attachment portion 22 at its lower end to be attached to the upper case 51. The upper case attachment portion 22 has substantially the same tubular shape as the base of the inner lens 2, and is inserted into a space defined by the inner retention walls 531, the outer retention wall 532 and the inner lens support base 533 (to be described later) when being attached to the upper case 51. The horizontal movement (excluding rotative movement) of the inserted inner lens 2 is restricted by the retention walls 531, 532. The inner lens 2 has an engagement cover attachment portion 21 at its upper end to be attached to the engagement cover 6. The engagement cover attachment portion 21 has substantially the same tubular shape as the base of the inner lens 2. Guide grooves (not shown) are provided in an inner surface of the inner lens 2 for guiding the substrate 41, so that the substrate 41 can be slid along the guide grooves when being inserted into the inner lens 2. This improves the productivity of the light emitting device 1. Where the guide grooves and rotation restricting projections are provided, the rotative movement of the inner lens 2 can be restricted, thereby further improving the productivity of the light emitting device 1.

The engagement cover 6 includes an engagement projection 61 engaged with an inner upper wall of the outer cover 3, a retention wall 62 having substantially the same size as the inner surface of the engagement cover attachment portion 21, a pair of substrate retaining plates 64 which support the substrate 41 from an upper side, and a main body 63 retaining these components. The retention wall 62 has a cylindrical shape, and projects downward from the main body 63. The retention wall 62 includes a multiplicity of resilient projections 621 equidistantly arranged on an outer peripheral surface thereof as extending axially. With the provision of the resilient projections 621, the engagement cover 6 is easily attached to the inner lens 2, and is less liable to be withdrawn from the inner lens 2. The pair of substrate retaining pieces 64 retain a notched upper end portion of the inserted substrate 41. In this case, the pair of substrate retaining pieces 64 are inserted along the guide grooves of the inner lens 2. The engagement cover 6 may be unified with a part of the upper face portion of the outer cover 3. In this case, the upper face portion of the outer cover 3 is preferably a light blocking member which prevents the external light from intruding into the inner lens 2.

Next, how to assemble the upper case 51, the light emitting member 4, the inner lens 2 and the engagement cover 6 will be described. First, the engagement cover 6 is attached to the inner lens 2. At this time, the substrate retaining pieces 64 of the engagement cover 6 extend along the guide grooves (not shown) of the inner lens 2. Then, the light emitting member 4 (substrate 41) is inserted along the guide grooves formed in the inner surface of the inner lens 2 from the lower side, and then inserted into the substrate retaining pieces 64 to be engaged with the substrate retaining pieces 64. Subsequently, the inner lens 2 attached with the light emitting member 4 (substrate 41) and the engagement cover 6 is inserted into the lamp retaining portion 53 of the upper case 51. Thus, the resulting lamp member is combined with the upper case 51. After the combining, the outer cover 3 is placed over the lamp member and the upper case 51 to surround the lamp member and the upper case 51. Then, a case attachment portion 32 provided at a lower end of the outer cover 3 is fixed to the outer cover attachment portion 54.

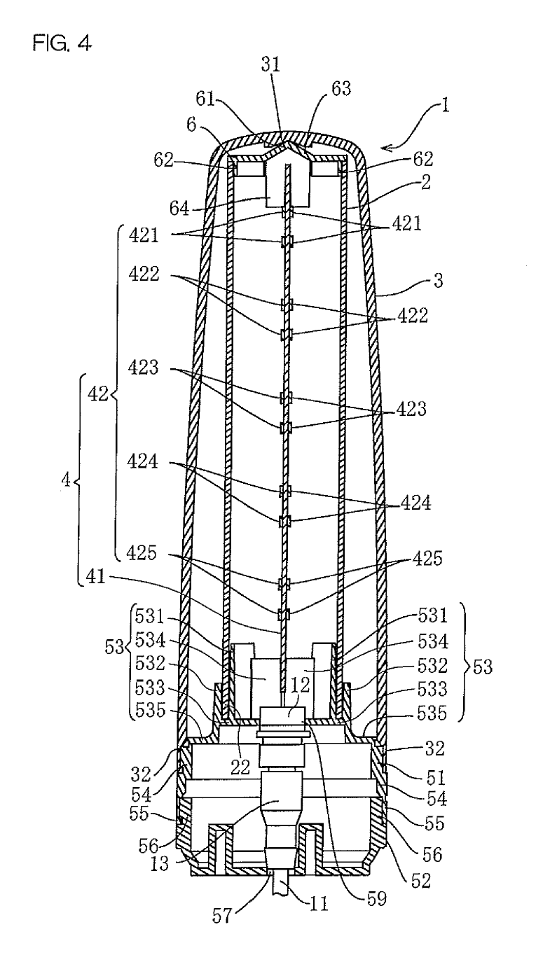

FIG. 4 is a vertical sectional view taken along a line S1-S1 in FIG. 1, illustrating a major portion of the light emitting device 1 in section. Referring to FIGS. 4, 2 and 3, a projection receiving portion 31 which guides and receives the engagement projection 61 of the engagement cover 6 is provided on the inner upper wall of the outer cover 3 integrally with the main body of the outer cover 3. The projection receiving portion 31 is a recessed member having an inverted M-shaped cross section. The engagement projection 61 has a shape such as to triangularly project upward from the center of the main body of the engagement cover 6 to be engaged with the recess of the projection receiving portion 31. The engagement projection 61 is brought into contact with the projection receiving portion 31 to be thereafter pressed downward when the outer cover 3 is attached to the case 5. At this time, the lower end of the inner lens 2 is brought into contact with the inner lens support base 533. Since the engagement cover 6 is made of a relatively soft material, the notched upper end portion of the substrate 41 is deeply inserted into slits of the substrate retaining portions 64 to be engaged with the engagement cover 6. On the other hand, the upper case 51 is made of a relatively hard material and, therefore, the notched lower end portion of the substrate 41 is inserted midway in the slits of the substrate retaining pieces 534 to be engaged with the upper case 51. A force to be applied during the engagement of the substrate 41 is controlled by controlling the length of the inner lens 2 according to the length of the substrate 41.

The inner lens support base 533 of the upper case 51 has a through-hole 59 provided at the center thereof, and the internal connector 12 is inserted in the through-hole 59 to be retained by the upper case 51. A gap between the outer cover 3 and the outer cover attachment portion 54 and a gap between the lower case attachment portion 55 of the upper case 51 and the upper case attachment portion 56 of the lower case are sealed with seal members for water proofing. With the light emitting device 1 mounted on the equipment machine 7, a gap between the bottom 14 of the light emitting device 1 and the equipment machine 7 is also water-proofed. Thus, the light emitting device 1 is water-proofed.

Next, a light emitting device 1A according to a second embodiment will be described. In the following, differences from the embodiment described above will be mainly described. Like components will be designated by like reference characters, and duplicate description will be omitted. In other embodiments and modifications to be described later, this policy is used. FIG. 5 is an exploded perspective view of the light emitting device according to the second embodiment of the present invention as seen from an upper side.

The light emitting device 1A according to the second embodiment has substantially the same construction as the light emitting device 1 according to the first embodiment, except that an inner lens 2A is used instead of the inner lens 2.

The inner lens 2A includes a tubular base made of a light diffusion material which diffuses light emitted from the light emitting member 4, half mirrors 23A (half mirrors 231A, 232A, 233A, 234A, 235A), and separators 24 (241, 242, 243, 244, 245). The half mirrors 23A are configured in the same manner as the half mirrors 23 (231, 232, 233, 234, 235) in the first embodiment.

Half mirrors having a higher reflectance than the half mirrors 23A or nontransparent members are employed as the separators 24. Where the former components are employed as the separators 24, the separators 24 can be formed by the same formation method as the half mirrors 23A. Where the latter components are employed as the separators 24, the separators 24 can be formed by the same formation method as the half mirrors 23A or by a hot stamp method.

The separators 24 include separators 241, 242, 243, 244 disposed between adjacent pairs of half mirrors 231A, 232A, 233A, 234A, 235A, and a separator 245 disposed below the half mirror 235A. With the provision of the separators 24, an observer can easily recognize the light emitted from the light emitting member 4 and passing through the inner lens 2A. Particularly, this arrangement is more effective when a plurality of light emitting members 4 are in the lighting state. In addition to the separators 24, partition plates or the like may be provided within the inner lens 2A so that light beams emitted from the respective light emitting members 4 are prevented from being mixed with each other.

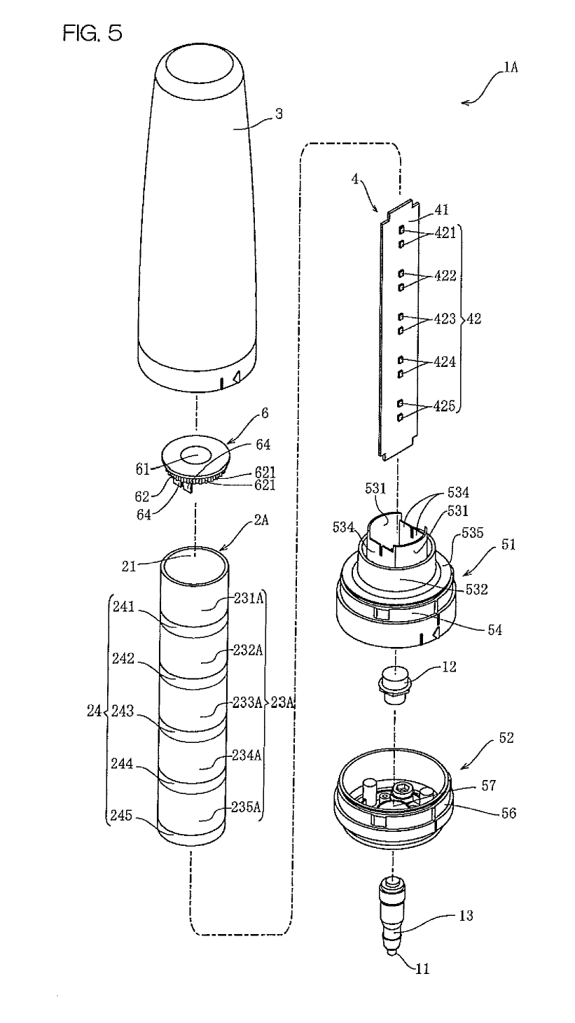

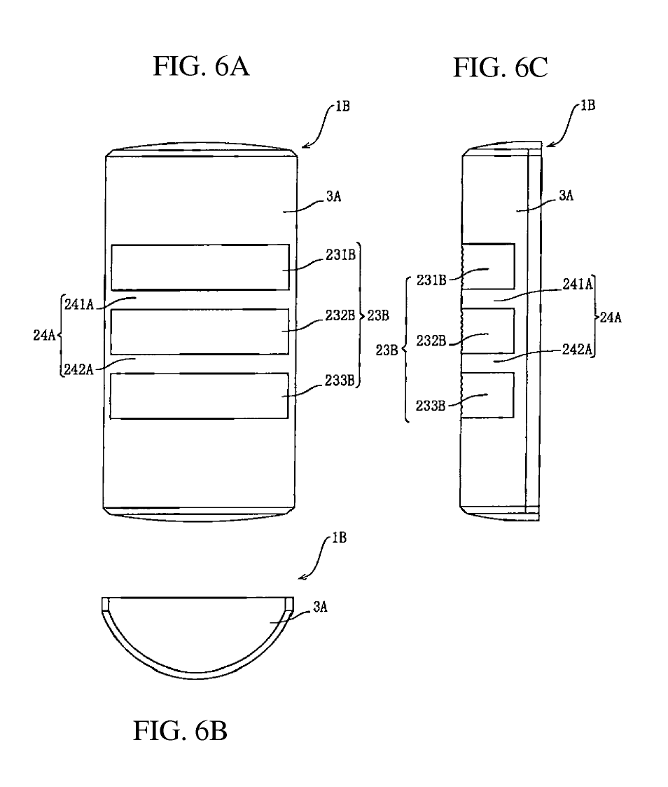

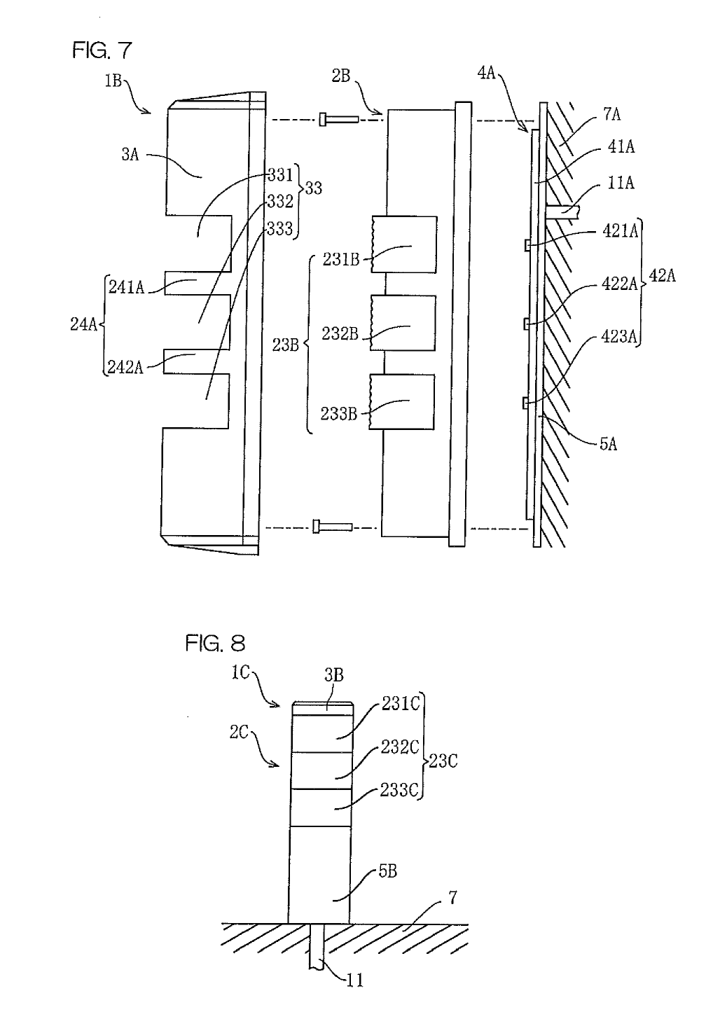

Next, a light emitting device 1B according to a third embodiment will be described. FIG. 6 shows diagrams illustrating a light emitting device according to a third embodiment. FIG. 7 is an exploded side view of the light emitting device according to the third embodiment.

Referring to FIG. 6, the light emitting device 1B is a signaling lamp to be mounted on a wall. The light emitting device 1B includes a semicircular outer cover 3A, an inner lens 2B surrounded by the outer cover 3A, a substrate 41A mounted with LEDs 42A (421A, 422A, 423A), and a wiring 11A. The outer cover 3A includes separators 24A (241A, 242A) fitted between half mirrors 23B (231B, 232B, 233B) of the inner lens 2B. The separators 24A are formed integrally with a surface of the outer cover 3A. In this embodiment, the surface of the outer cover 3A is mirror-finished. Therefore, the color of the light emitting device 1B easily matches the exterior color of an equipment machine on which the light emitting device 1B is mounted, because the light emitting device 1B can entirely have a metallic appearance (substantially the same color). Thus, the light emitting device 1B is less conspicuous in an unlighting state. Of course, the light emitted from the LEDs 42 is radiated through the half mirrors 23B in the lighting state, so that the light emitting device 1B has a signaling function as the signaling lamp.

Referring to FIGS. 6 and 7, the outer cover 3A has windows 33 (331, 332, 333) positioned as corresponding to the half mirrors 23B (231B, 232B, 233B) of the inner lens 2B. The half mirrors 23B project from a main body of the inner lens 2B. Only the half mirrors 23B of the inner lens 2B are required to be subjected to a half mirror treatment. A light emitting member 4A includes the plurality of LEDs 42A (421A, 422A, 423A) mounted on the substrate 41A. A case 5A supports the light emitting member 4A, and retains the inner lens 2B and the outer cover 3A on a side surface of the equipment machine 7A by means of screws or the like.

In the third embodiment, the outer cover 3A is described as a part of the light emitting device 1B. Alternatively, a portion of the light emitting device 1B except for the outer cover 3A may be embedded in the equipment machine 7A, and the outer cover 3A may be defined by a surface panel of the equipment machine. Where the light emitting device 1B does not require water-proofing and drip-proofing, the outer cover 3A may be obviated. In this case, the exterior appearance of the light emitting device 1B can be assimilated to the exterior appearance of the equipment machine 7A on which the light emitting device 1B is mounted. This increases the sense of unity between the light emitting device 1B and the equipment machine, making the light emitting device 1B less conspicuous in the unlighting state.

Next, a light emitting device 1C according to a fourth embodiment will be described. FIG. 8 is a diagram illustrating the light emitting device according to the fourth embodiment. In the light emitting device 1C, an inner lens 2C having half mirrors 23C (231C, 232C, 233C) is provided on a case 5B. In the fourth embodiment, the outer cover 3B is formed integrally with the inner lens 2C to prevent external light from intruding into the inner lens 2C from an upper side of the light emitting device 1C. Where the case 5B has a metallic appearance, it is easier to match the color of the half mirrors 23C to the color of the case 5B, thereby making the light emitting device less conspicuous.

The present invention is not limited to the embodiments described above, but various modifications may be made within the scope of the present invention defined by the appended claims.

What is claimed is:

1. A light emitting device comprising:
a light source which emits light; and
an inner lens which has an inner surface and an outer surface, and permits the light emitted from the light source to pass therethrough from the inner surface to radiate the light outside from the outer surface;
wherein the inner lens includes a half mirror portion through which the light passes;
wherein the half mirror portion has a characteristic property such as to permit the light to pass therethrough from an inside to an outside of the inner lens and reflect external light traveling from the outside toward the inside.

2. The light emitting device according to claim 1, wherein the inner lens is a tubular body which surrounds the light source.

3. The light emitting device according to claim 2, further comprising a case to which the inner lens is attached,
wherein the case retains a lower portion of the tubular inner lens in a self-standing state and has a tubular body retaining portion which prevents the external light from intruding into the inner lens.

4. The light emitting device according to claim 3, wherein the half mirror portion is partitioned into a plurality of portions by a nontransparent portion or a half mirror portion having a higher reflectance according to an accommodated light source position and a light emitting direction.

5. The light emitting device according to claim 1, further comprising:
an outer cover provided outside the inner lens; and
an engagement cover attached to an upper portion of the inner lens,
wherein the engagement cover is resiliently engaged with an upper inner surface portion of the outer cover.

6. The light emitting device according to claim 2, further comprising:
an outer cover provided outside the inner lens; and
an engagement cover attached to an upper portion of the inner lens,
wherein the engagement cover is resiliently engaged with an upper inner surface portion of the outer cover.

7. The light emitting device according to claim 1, further comprising an outer cover provided outside the inner lens,
wherein the inner lens radiates the light outside through the outer cover.

8. The light emitting device according to claim 7,
wherein the outer cover is a surface panel of the equipment machine.

9. The light emitting device according to claim 7,
wherein the outer cover has a window as the opening for permitting passage of the light;
wherein the half mirror portion of the inner lens is fitted in the window so as to be flush with a surface of the outer cover.

10. The light emitting device according to claim 8,
wherein the outer cover has a window as the opening for permitting passage of the light;
wherein the half mirror portion of the inner lens is fitted in the window so as to be flush with a surface of the outer cover.

11. The light emitting device according to claim 1, wherein the half mirror portion includes a plurality of half mirror portions having different optical properties.

12. The light emitting device according to claim 11, wherein the differences among the optical properties of half mirror portions include a difference in color.
